(19) United States
(12) Patent Application Publication
(10) Pub. No.: US 2008/0103880 A1
(43) Pub. Date: May 1, 2008

(54) Computer-implemented method and system for collecting votes in a decision model

(75) Inventor: Daniel Saaty, Falls Church, VA (US)

Correspondence Address: POSZ LAW GROUP, PLC, 12040 SOUTH LAKES DRIVE, SUITE 101, RESTON, VA, 20191, US

(73) Assignee: Decision Lens, Inc., Falls Church, VA (US)

(21) Appl. No.: 11/586,557

(22) Filed: Oct. 26, 2006

(51) Int. Cl. G07C 13/00

(52) U.S. Cl. 705/12

(57) ABSTRACT

A computer-implemented method provides for collecting votes on importances in an existing analytic network process (ANP) model, the ANP model having items which are influence linked. The votes to be collected are determined, wherein the votes are with respect to items in the ANP model, the items being influence linked, and wherein a vote represents an importance of two or more influence linked items. An item can be a control criteria, an element, or a cluster. Also, at least a portion of the votes are collected automatically or semi-automatically, including collecting votes on two or more pairs of items where the items are in the same cluster with respect to a different item that is in the same cluster or a different cluster, and collecting votes on items where the items are clusters or control criteria.

### BACKGROUND OF THE INVENTION

1. Field of the Invention

The present invention relates in general to computerized analyses of decisions to be made in order to evaluate systems of interacting variables, and one or more embodiments more specifically relates to utilizing an analytic network process model as the decision model.

2. Description of the Related Art

An analytic network process (“ANP”) is a method of structuring complex decisions or systems of interacting variables to enable users to define the relationships between the variables through a mathematically based process for prioritizing the components of the ANP. The purpose of any particular ANP network may include, for example, to make a decision, to predict outcomes, to prioritize a large set of alternatives, or simply to gain a better understanding of the interaction effects between components of a complex system.

Variables in an ANP model typically include, for example, an overall goal; or the benefits, costs, risks and opportunities can be used as perspectives or merits to evaluate alternatives or other factors in the networks. Variables can also include lower levels of control criteria which can be organized in a single hierarchy or multiple hierarchies and can be overriding criteria based on which judgments are performed within networks. An ANP model is intended to be flexible to cover the wide variety of decisions and/or interacting variables that can be considered in business, government, education, or for private purposes.

Any particular ANP model can have multiple control hierarchies and multiple networks attached to the control criteria in the hierarchies. In a network of an ANP model, there can be clusters which are logical groupings of decision elements.

In conventional implementations of decision models, a participant can enter information in any part of the decision model. There is no method for managing what the participants can vote on. Moreover, a user can be exposed to the full complexity of the decision model in which he/she is participating.

### BRIEF DESCRIPTION OF THE SEVERAL VIEWS OF THE DRAWING(S)

The accompanying figures where like reference numerals refer to identical or functionally similar elements and which together with the detailed description below are incorporated in and form part of the specification, serve to further illustrate an exemplary embodiment and to explain various principles and advantages in accordance with the present invention.

FIG. 1 is a block diagram illustrating a simplified and representative example analytic network process model for use in connection with one or more embodiments.

FIG. 2 is a block diagram illustrating a simplified and representative example of clusters, in accordance with one or more embodiments.

FIG. 3 is a diagram illustrating an exemplary judgment matrix, in accordance with one or more embodiments.

FIG. 4 is a block diagram illustrating an exemplary super matrix, in accordance with one or more embodiments.

FIG. 5 is a block diagram illustrating portions of an exemplary computer, in accordance with various exemplary embodiments.

FIG. 6 is a block diagram illustrating an environment for use in connection with an exemplary computer, in accordance with various exemplary embodiments.

FIG. 7 is a flow chart illustrating an exemplary procedure for collecting votes on importances, in accordance with various exemplary and alternative exemplary embodiments.

### DETAILED DESCRIPTION

In overview, the present disclosure concerns computers, computer networks and computer systems, such as an intranet, local area network, distributed network, or the like having a capability of analyzing variables in decision models. Such computer networks and computer systems may further provide services such as interacting with users, and/or evaluating modifications to a decision model. More particularly, various inventive concepts and principles are embodied in systems, devices, and methods therein related to voting for a decision model and evaluating changes in a decision model. It should be noted that the term device may be used interchangeably herein with computer, wireless communication unit, or the like. Examples of such devices include personal computers, general purpose computers, personal digital assistants, cellular handsets, and equivalents thereof.

The following detailed description includes many specific details. The inclusion of such details is for the purpose of illustration only and should not be understood to limit the invention. Throughout this discussion, similar elements are referred to by similar numbers in the various figures for ease of reference. In addition, features in one embodiment may be combined with features in other embodiments of the invention.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, are best supported with or in software or integrated circuits (ICs), such as a digital signal processor and software therefore or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring the principles and concepts according to the present invention, further discussion of such software and ICs, if any, will be limited to the essentials with respect to the principles and concepts used by the exemplary embodiments.

As further discussed herein below, various inventive principles and combinations thereof are advantageously employed to develop a decision model, such as an analytic network process (ANP) decision feedback network, to control voting by different participant users and manage voting based on participant users. One or more embodiments supports having different users assigned access to different parts of the decision model.

A decision model, such as an ANP model, can be designed to enable users to selectively participate in a structured process of prioritizing the components of a model using a process of comparing control criteria to one another for the importance in the decision, followed by comparing the clusters to one another for their relative importance in the decision with respect to the control criteria, and finally comparing the elements for their relative importance in the decision with respect to the clusters and control criteria.

If the decision model includes benefits, costs, risks and opportunities, known techniques can be utilized for aggregating the information across the entire model. For example, benefits+opportunities−risks−costs, can be used to determine the overall value of each alternative course of action. As another example, (benefits*opportunities/risks*costs) can be used for each alternative.

The term “user” is utilized herein to indicate the entity answering the questions, e.g., a person voting. The user can vote utilizing a device to input the vote.

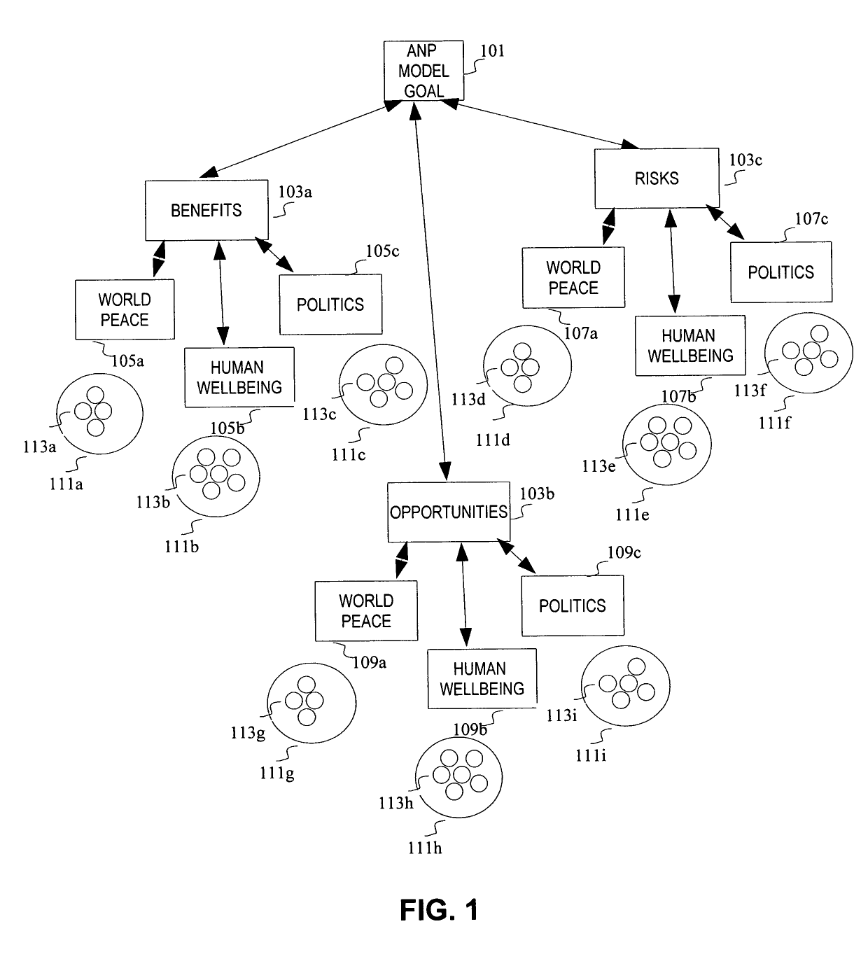

Referring now to FIG. 1, a block diagram illustrating a simplified and representative example analytic network process (ANP) model for use in connection with one or more embodiments will be discussed and described. The illustrated model structure includes an ANP model goal 101; perspectives or merits 103a-103c; control criteria 105a-c, 107a-c, 109a-c; networks 111a-111i; and clusters 113a-113i.

In accordance with one or more embodiments, control criteria 105a-c, 107a-c, 109a-c can be compared against one another utilizing pairwise comparisons. In the decision model, below each of the control criteria 105a-c, 107a-c, 109a-c are networks 111a-111i and/or sub-networks of clusters interacting decision factors (i.e., elements). Clusters 113a-113i, or specific elements within clusters, can be influence linked.

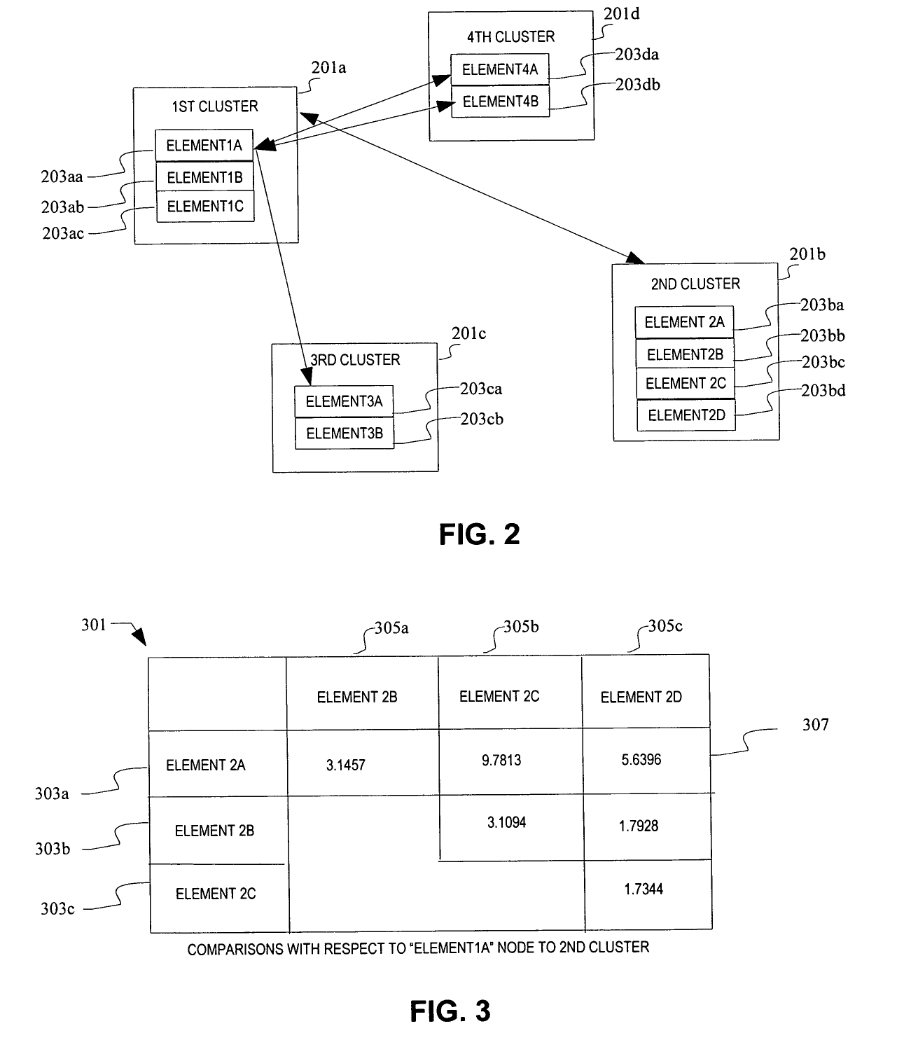

Elements (not illustrated) which are in clusters 113a-113i, and which are influence linked can be pairwise compared with respect to clusters 113a-113i and control criteria 105a-c, 107a-c, 109a-c. Clusters 113a-113i can be pairwise compared with respect to control criteria 105a-c, 107a-c, 109a-c. Control criteria 105a-c, 107a-c, 109a-c can be pairwise compared with respect to the goal 101. Influence linking is discussed in more detail in connection with FIG. 2.

In the illustrated embodiment, the perspectives or merits 103a-103c include benefits, risks, and opportunities. The control criteria 105a-c, 107a-c, 109a-c include world peace, human wellbeing, and politics. The clusters 113a-113i in the illustrated embodiment are not labeled with definitions, but might include, e.g., freedom, in which the elements could be legal freedom and social freedom; health, in which the elements could be no starvation, and less disease; and others.

Pairwise comparisons need not be performed in any particular order. Furthermore, elements can be weighted, if desired. In addition, one or more embodiments can provide a vote control structure enveloping an existing decision model, where users are only allowed to vote on a pre-determined portion of a decision model based on user identification and/or a role assigned to a user. The votes can be collected to generate a comparison matrix representing the respective portion of the model.

Referring now to FIG. 2, a block diagram illustrating a simplified and representative example of clusters in accordance with one or more embodiments will be discussed and described. There are four clusters 201a-d illustrated here, representative of any number of clusters in a particular embodiment. Each of the clusters 201a-d can include various elements, here represented by elements 1A-1C 203aa-ac, 2A-2D 203ba-bd, 3A-3B 203ca-cb, and 4A-4B 203da-db. The elements in each cluster in the illustration are merely representative of any number of elements in any number of clusters.

A cluster can be influence linked to another cluster, thereby indicating that each element of one cluster is to be compared to each element of the other cluster. In the illustration, the first cluster and the second cluster 201a, 201b are influence linked. Therefore, each element within the first cluster 201a, that is element 1A-1C 203aa-203ac, will be individually compared with pairs of each element in the second cluster 201b, that is element 2A-2D 203ba-203bd. Because the link is bidirectional in this example, each of the elements within the second cluster 201b will be compared with pairs of each of the elements in the first cluster 201a.

Although the illustrated example shows two clusters that are influence linked, a cluster can be linked to any number of other clusters, or can be linked to none. In the illustrated example, each pair of elements in the first cluster is compared with respect to each element in the second cluster.

Individual elements can be influence linked to one or more clusters or to one or more other elements, to indicate that the element is to be compared to the elements in the cluster(s) and/or compared to the other element(s). In the illustrated example, element 1A 203aa is influenced linked to elements 4A-4B 203da-203db; and element 3A 203ca is influence linked to element 1A 203aa. Therefore, the combinations of elements that are compared is element 1A-element 4A, element 1A-element 4B, and element 1A-element 3A. The illustrated example is representative of any number of elements that can be influence linked, and is not meant to be restrictive. Accordingly, one or more embodiments can provide for automatically determining, in the computer, a plurality of items in the pairwise comparisons responsive to influence links of the items corresponding to the collected votes.

Items in the ANP model are grouped into clusters, with influence links between at least some of the items. An influence link can be provided as follows. A first item in a cluster, identified as a parent item can be selected. One or more other items in that same cluster or in another cluster can be selected, to which the parent item is linked, the second items being identified as children. All of the children can be in the same cluster. The parent and these children comprise a pairwise comparison set. Note that a parent item can have plural sets of children, comprising plural pairwise comparison sets.

When a parent item in a cluster is linked to items in that cluster or other clusters, the clusters themselves are therefore influence linked. When a cluster is linked to more than one other clusters, the clusters to which it is linked can be pairwise compared with respect to the first cluster.

The influence linked items can be compared, for example, to provide a rating or to determine relative importance. For example, to determine a relative importance in the example of FIG. 2, the following votes can be obtained: (1) With respect to element 1A, which is more important, element 4A or element 4B? (2) With respect to element 1A, which is more important, element 3A or element 4A? (3) With respect to element 1A, which is more important, element 3A or element 4B? (4) And so on, for each of the influence linked items (elements and elements within clusters). When the items are to be compared are known, the phrasing of the votes to be obtained can be determined in accordance with known techniques.

It will be appreciated that the clusters and elements, represented here by generic terms “1ST CLUSTER,” “ELEMENT1A” and the like, in operation are associated with descriptors. Therefore, a cluster with the descriptor “Alternatives” may include elements with the descriptors “McDonalds,” “Burger King,” and “Wendy's.” A cluster with the descriptor “Public Health” may include elements with the descriptors “food hygiene” and “site hygiene.” A cluster with the descriptor “Contemporary” may include elements with the descriptors “nutrition,” “recycling,” “waste disposal,” and “over packaging.” Therefore, comparisons to determine relative importance can be, for example, “with respect to McDonalds, which is more important, nutrition or recycling?” “with respect to McDonalds, which is more important, nutrition or waste disposal?,” and so on. Alternatively, comparisons to determine rating can be, for example, “with respect to McDonalds, rank the following: nutrition, recycling, waste disposal, and over packaging,” and so on. As another alternative, rating can be determined, for example, “with respect to McDonalds, indicate the rating for nutrition: excellent, very good, good, marginal, poor,” where excellent represents a rating of 1.0 and poor represents a rating of 0. Alternatively, a numerical rating scale can be utilized to rank elements, for example a McDonalds lunch with zero grams of fat can be a 1.0 for nutrition, whereas a lunch with 30 grams of fat can be a 0 for nutrition. Any number in a range can be interpolated. The association of clusters and elements with descriptors, and their use, is a known technique. Also, there are many known techniques for obtaining rating and/or relative importances of two or more things, which are amenable to being applied to decision models. Accordingly, one or more embodiments can provide that the importance represents a rating, or that the importance is relative to the influence linked items.

The term “influence linked” or similar is used herein to indicate an item, such as a cluster or element or the like, that is linked to another item. A particular link can be a forward link, a backward link, or bidirectional link. The influence link can be represented in a computer by, for example, a pointer, a link, an address, or the like. One or more embodiments can provide that a particular network with particular clusters and elements can appear in more than one place in the ANP model; duplicate appearances in the ANP model of the same particular network can have the same influence linking. Accordingly, one or more embodiments can provide for evaluating the first items to determine second items to which respective first items are influence linked.

Accordingly, one or more embodiments can provide for providing an ANP model including first and second items which are influence linked, wherein an item is a cluster, a control criteria, or an element; and determining the votes to be collected, wherein the votes are with respect to first items in the ANP model, the first items being influence linked to respective second items in the ANP model, wherein a vote represents an importance of respective first and second items.

In one or more embodiments, it may be useful to represent the ANP model in the computer as a set of trees. For example, a judgment matrix itself can be a set of trees. However, alternative embodiments can include, for example, hierarchical databases.

Referring now to FIG. 3, a diagram illustrating an exemplary judgment matrix 301 in accordance with one or more embodiments will be discussed and described. The judgment matrix 301 can stores priorities, such as a value 307, of the comparisons of elements within a cluster to other elements in the same cluster.

The illustrated example is a judgment matrix 301 with respect to the element 1A node of the first cluster, in connection with the second cluster (illustrated in FIG. 2). Consider, for example, that element 1A of the first cluster is “McDonalds”, and elements 2A, 2B, 2C and 2D of the second cluster are the following, respectively: nutrition, recycling, waste disposal, and over packaging. Each element 305a, 305b, 305c is compared with each other element 303a, 303b, 303c.

Here, votes have been collected on these items from one or more users. Possibly, votes have been collected from one or more of the users on only a part of the judgment matrix. For example, a user might have voted only on the element 1A (e.g., McDonalds) in relation to elements 2A and 2B (e.g., nutrition and recycling). Another user might have voted on a different element (e.g., Wendy's) in relation to all elements 2A, 2B, 2C, 2D. The collected votes can be used to calculate the values in the judgment matrix.

The term “judgment matrix” is used to indicate a matrix for holding values of a set of elements that are to be compared to one another in relation to another element. In typical embodiments, the set of elements are two or more elements within the same cluster, and the other element is in a different cluster. However, it is possible that the elements in the set are in different clusters. It is possible that the other element is in the same cluster as the elements to be compared. In alternative embodiments, the set of elements are compared to two or more other elements.

The priorities, e.g., values 307, of the comparisons of elements based on collected votes can be calculated in accordance with techniques that are known, for example, geometric averages, which will not be discussed further herein to avoid obscuring the discussion. Such known techniques can be applied within the judgment matrix. Also, votes can be weighted, for example, with respect to different users who provided the votes. Accordingly, one or embodiments can provide for calculating priorities from the judgment matrix. Moreover, accordingly, one or more embodiments can provide for calculating an average of plural judgment matrices including the judgment matrix; and determining an average of the pairwise comparisons, wherein the votes in the judgment matrices are from different users.

There can be many pairwise comparison matrices in an ANP model. A single individual can provide some or all of the votes in a pairwise comparison matrix, or more than one individual may provide some or all of the votes. When more than one individual provides votes for a particular cell of a pairwise comparison matrix, the many individual votes will be synthesized, for example, using a geometric mean. It is possible that one individual can provide the only vote in one cell while more than one individual can provide votes in another cell in the same pairwise comparison matrix.

The votes resulting from the calculation can be used to calculate a priority vector (sometimes referred to as a value or priority) for the pairwise comparison matrix. The priority vectors for all the pairwise comparison matrices associated with a particular ANP model can be used to populate a supermatrix corresponding to the ANP model.

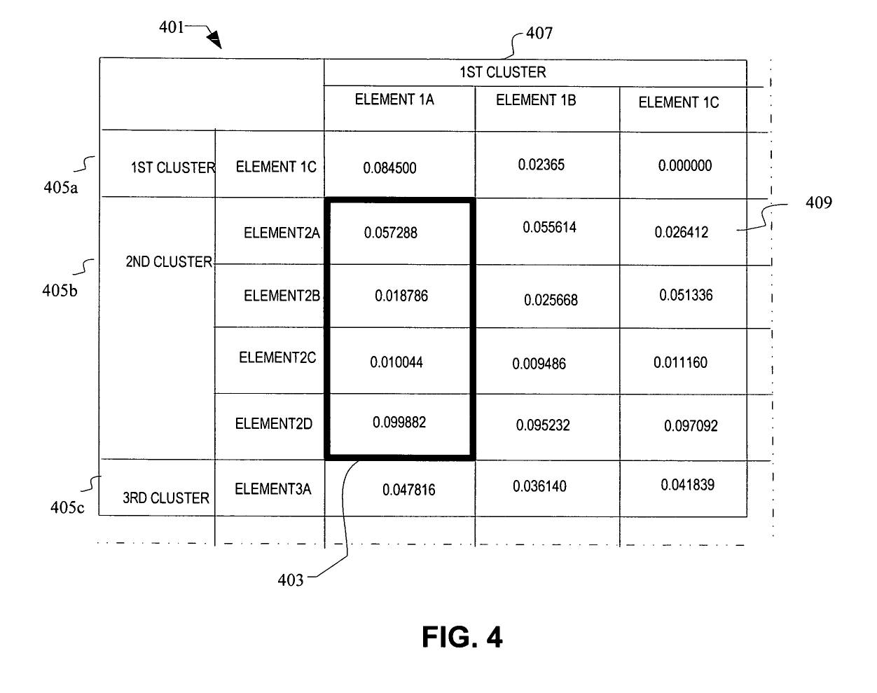

Referring now to FIG. 4, a block diagram illustrating an exemplary super matrix in accordance with one or more embodiments will be discussed and described. The illustrated example is a super matrix 401 with respect to the network of clusters illustrated and discussed in connection with FIG. 2: first cluster 405a, second cluster 405b, third cluster 405c, and fourth cluster (not illustrated).

In the super matrix 401, values 409 have been calculated from the respective judgment matrices. For example, the judgment matrix 403 of values of the second cluster 405b with respect to element 1A of the first cluster 407 were previously calculated.

The value 409 of the comparisons of elements can be calculated from the judgment matrices in accordance with known techniques, for example, geometric averages, which will not be discussed further herein to avoid obscuring the discussion. Also, judgment matrices and/or values 409 can be weighted.

Accordingly, one or more embodiments can provide for populating the priorities into a super matrix representing a network in the ANP model.

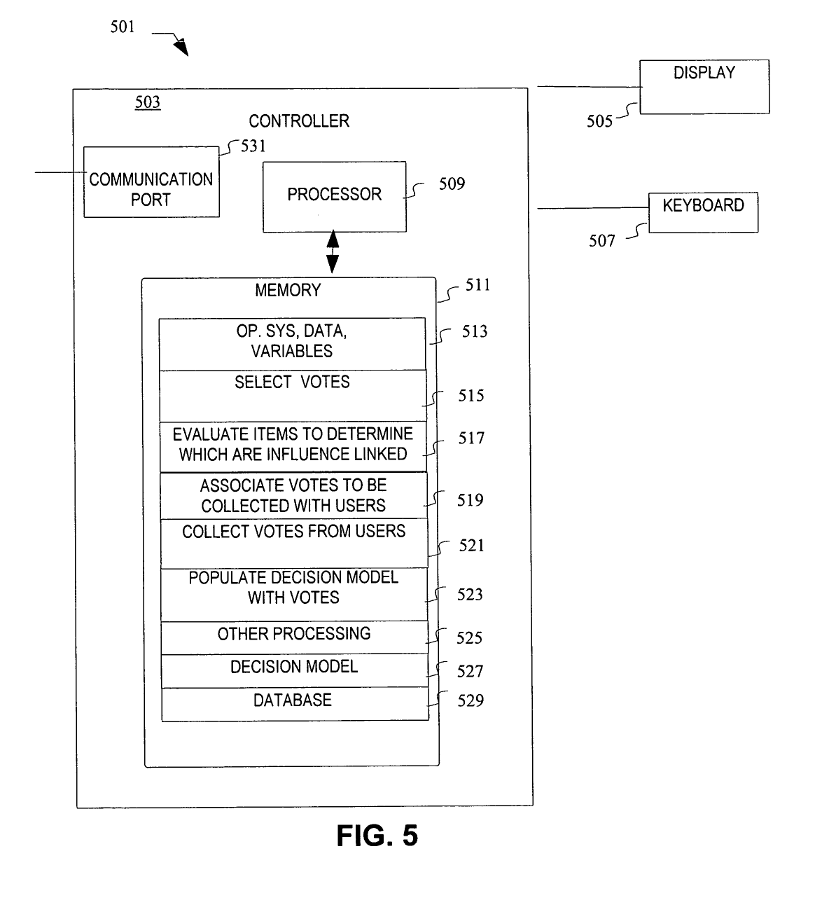

Referring now to FIG. 5, a block diagram illustrating portions of an exemplary computer in accordance with various exemplary embodiments will be discussed and described. The computer 501, such as a computer-implemented device, may include one or more controllers 503. The controller 503 can be operably connected to a communication port 531 for sending and receiving transmissions on a network, a text and/or image display 505, and/or a user input device such as a keyboard 507. The controller 503 can also include a processor 509 and a memory 511.

The processor 509 may comprise one or more microprocessors and/or one or more digital signal processors. The memory 511 may be coupled to the processor 509 and may comprise a read-only memory (ROM), a random-access memory (RAM), a programmable ROM (PROM), and/or an electrically erasable read-only memory (EEPROM). The memory 511 may include multiple memory locations for storing, among other things, an operating system, data and variables 513 for programs executed by the processor 509; computer programs for causing the processor to operate in connection with various functions such as selecting votes 515, evaluating items to determine which are influence linked 517, associating votes to be collected with users 519, collecting votes from users 521, populating the decision model with votes 523, and other optional processing 525; a database 527 of information used in connection with the decision model; and a database (529) of other information used by the processor 509. The computer programs may be stored, for example, in ROM or PROM and may direct the processor 509 in controlling the operation of the computer 501. Accordingly, one or more embodiments can provide for a computer-implemented system for collecting information on importances of elements in a decision model.

The processor 509 may be programmed for selecting votes 515. Selecting votes can include, for example, selecting, in response to a given set of items, at least one of those other items to which they are influence linked. Using FIG. 2 for example, given a set of items including elements 1A and 1B, elements 4A and 4B are selected. Then, two or more of the other items are associated with one of the given items, so that the items can be voted on. Again, using FIG. 2 for example, elements 4A and 4B are associated with element 1A, so that a vote can be collected on the relative importance of elements 4A and 4B with respect to element 1A. Accordingly, one or more embodiments can provide for a vote selection unit, configured to facilitate selecting, responsive to a plurality of first items, plural sets of influence linked items on which votes are to be collected, wherein a vote represents an importance of influence linked items in respective sets; and automatically or semi-automatically associating, in the computer, at least two respective second items in the respective set responsive to the respective first item, wherein the first item and the at least two respective second items in the respective set can have different types.

The processor 509 also may be programmed for evaluating items to determine which are influence linked 517. When an item is selected, the processor can determine which other items the selected item is linked to. Referring again to FIG. 2 for example, given element 1A, by examining the links associated with element 1A, it is determined that elements 4A and 4B are influence linked to element 1A. Accordingly, one or more embodiments can provide for an influence linked item determination unit, responsive to a first item, configured to facilitate automatically determining, in the computer, at least two respective second items to which the first item is influence linked in the decision model, wherein types of items in the decision model include control criteria, elements, and clusters.

The processor 509 also may be programmed for associating votes (or a portion of votes) to be collected with particular users 519. Therefore, the processor can indicate which votes and/or elements a particular user is to vote one. For example, a user indicator (e.g., a unique identifier) can be associated with particular votes to be collected, and/or elements. When the votes are collected, a user associated with the user indicator can be limited to voting on those particular votes and/or elements, for example. Again, referring to FIG. 2 for example, one or more users can be limited to voting with respect to McDonald's, but not for Wendy's. Accordingly, one or more embodiments can provide that the vote selection unit associates, responsive to a user indicator, a particular user with a particular portion of the votes to be collected.

The processor 509 also may be programmed for collecting votes from users 521. For example, the computer 501 can be configured to facilitate interacting with a user so the user can indicate votes, and/or the computer 501 can be configured to facilitate receiving an indication of the user's votes. Where the computer 501 interacts with the user, the computer 501 can determine the user indicator for the user, and the votes can be collected for that portion of votes associated with the user indicator. Accordingly, one or more embodiments can provide for a vote collection unit configured to facilitate collecting a plurality of votes between items in the respective sets. Also accordingly, one or more embodiments provides for collecting votes for the particular portion with respect to the user indicator. Further accordingly, one or more embodiments can provide that the vote collection unit limits each user to voting on a particular predetermined portion of the control criteria, elements, and clusters. As described below, users may be assigned a role, and votes can be limited to users with particular roles. Accordingly, one or more embodiments can provide that the vote collection unit is role-based.

The processor 509 also may be programmed for populating the decision model with votes 523. In accordance with one or more embodiments, the votes are first collected into a judgment matrix, values are calculated from the judgment matrix (for example, determining an average of pairwise comparisons in the judgment matrix), and the values from the judgment matrix are populated into a super matrix representing a network in the decision model.

The memory 511 provided in association with the processor 509 can store the database 527 for the information used in connection with the decision model, for example, an ANP model. The decision model, or portions thereof, can be located in the memory 511. Alternatively, the database 527 can provide access to the decision model, for storing and/or retrieving information from the decision model, where the decision model is stored locally or remotely for access. Accordingly, one or more embodiments can provide for a memory storing the decision model, the decision model having the items which are influence linked, including the first items and the second items; and a decision model population unit, responsive to at least a portion of votes which have been collected, configured to facilitate populating the collected votes into a corresponding portion of the decision model.

Optionally, other components may be incorporated in the computer 501 to produce other actions. For example, a user can interface with the computer 501, via a known user interface such as OUTLOOK, WINDOWS, and/or other commercially available interfaces. Further, the computer 501 can send and receive transmissions via known networking applications operating with the communications port 531 connected to a network, for example, a local area network, intranet, or the Internet and support software.

It should be understood that various embodiments are described herein in connection with logical groupings of programming of functions. One or more embodiments may omit one or more of these logical groupings. Likewise, in one or more embodiments, functions may be grouped differently, combined, or augmented. For example, in one or more embodiments, evaluating the result of voting can be done separately from determining the votes to be collected, and accordingly the computer 501 can separate out the functions of selecting the votes, collecting the votes from users, and populating the decision model with the votes. In addition, some of these functions may be performed predominantly or entirely on one or more remote computers (not illustrated); and therefore such functions can be reduced or omitted from the processor 509 and distributed to the remote computer. Similarly, the present description may describe various databases or collections of data and information. One or more embodiments can provide that databases or collections of data and information can be distributed, combined, or augmented, or provided locally (as illustrated) and/or remotely (not illustrated).

The user may invoke functions accessible through the keyboard 507. As alternatives to the keyboard 507, or in addition to the keyboard 507, one or more other various known input devices can be provided, such as a keypad, a computer mouse, a touchpad, a touch screen, a trackball, and/or a pointing device. The keyboard is optional for one or more embodiments.

The computer 501 can include or be connected to the text and/or image display 505, upon which information may be displayed. The display is optional for one or more embodiments. The display 505 may present information to the user by way of a conventional liquid crystal display (LCD) or other visual display, and/or by way of a conventional audible device (such as a speaker, not illustrated) for playing out audible information.

The computer 501 can include one or more of the following, not illustrated: a floppy disk drive, a hard disk drive (not shown), and a CD ROM or digital video/versatile disk, at internal or external hard drives. The number and type of drives can vary, as is typical with different configurations, and may be omitted. Instructions for operating the processor 509 can be provided electronically, for example, from the drive, via the communication port 531, or via the memory 511. Accordingly, one or more embodiments provide for a computer-readable medium comprising instructions for execution by a computer, where the instructions include a computer-implemented method for collecting votes on importances in an existing analytic network process model.

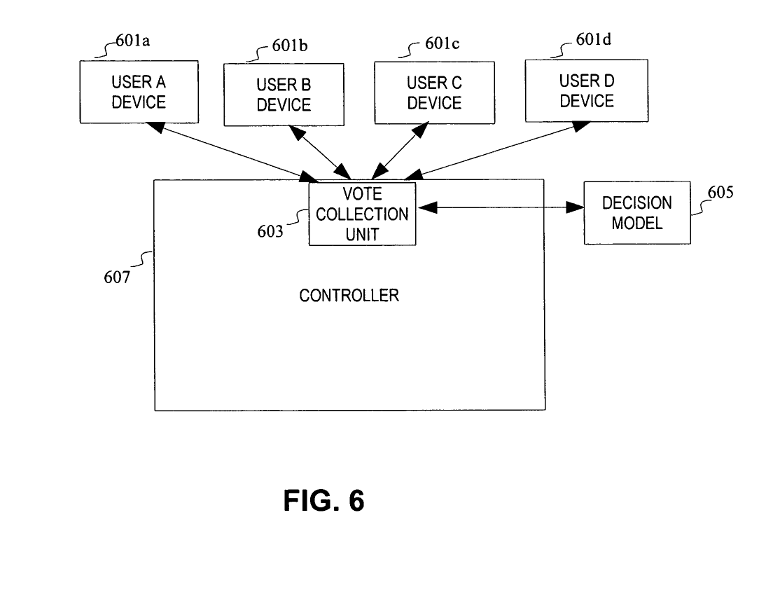

Referring now to FIG. 6, a block diagram illustrating an environment for use in connection with an exemplary computer in accordance with various exemplary embodiments will be discussed and described. In the illustrated embodiment, there is provided a controller 607, with a vote collection unit 603. The vote collection unit 603 can access a decision model 605, for example for storing votes that are collected and/or for determining which votes are to be collected. Users can interact via user devices 601a, 601b, 601c, 601d with the vote collection unit 603. The user devices can be remote or local, as further described herein.

A particular user can be limited to particular votes. For example, portions of the votes to be collected can be associated with particular users. Accordingly, one or more embodiments can provide that at least one of the particular users is limited to voting on an associated one of the respective portions. Also, accordingly, one or more embodiments can provide for associating respective portions of the votes to be collected with particular users in a plurality of users, wherein one of the particular users can vote on the respective associated portion.

Accordingly, one or more embodiments can provide for collecting votes from a plurality of users, wherein a particular user can cast votes for a predetermined portion of the ANP model, wherein the votes for a particular user reflect a user's indication of a relationship between a first item and at least two second items which are influence-linked to the first item.

One or more embodiments provide that a user can be associated with a role, where there are multiple roles, and any of the roles can be assigned to plural users. Roles could include, for example, legal, marketing, and the like, as desired. Roles can be assigned to users that vote, and/or to reviewers with access to the decision model (referred to as “reviewers”). Portions of the votes to be collected can be associated with particular roles, and therefore can be associated (directly or indirectly) with particular users. Similarly, portions of the decision model can be assigned to roles of reviewers, and access of a particular reviewer can be limited to those portions of the decision model that have a role corresponding to the role assigned to the particular reviewer. Accordingly, one or more embodiments can provide for assigning users to respective roles; and determining the users from which to collect the votes by determining votes corresponding to roles and users corresponding to roles.

Moreover, because users can be associated with particular votes in the ANP model, it is not necessary to allow the user access to information about portions of the ANP model with which they are not associated. Accordingly, one or more embodiments can provide for collecting votes on respective associated portions from respective ones of the particular users, wherein the collecting further includes limiting information provided to the particular user about the ANP model to the respective associated portion of the ANP model.

Votes can be populated into the decision model 605, as described herein, in real time as the votes are collected, and/or in batch mode for groups of votes which are collected. Moreover, votes can be temporarily populated, but not permanently stored, so that for example an effect of voting different ways can be determined on other portions of the decision model.

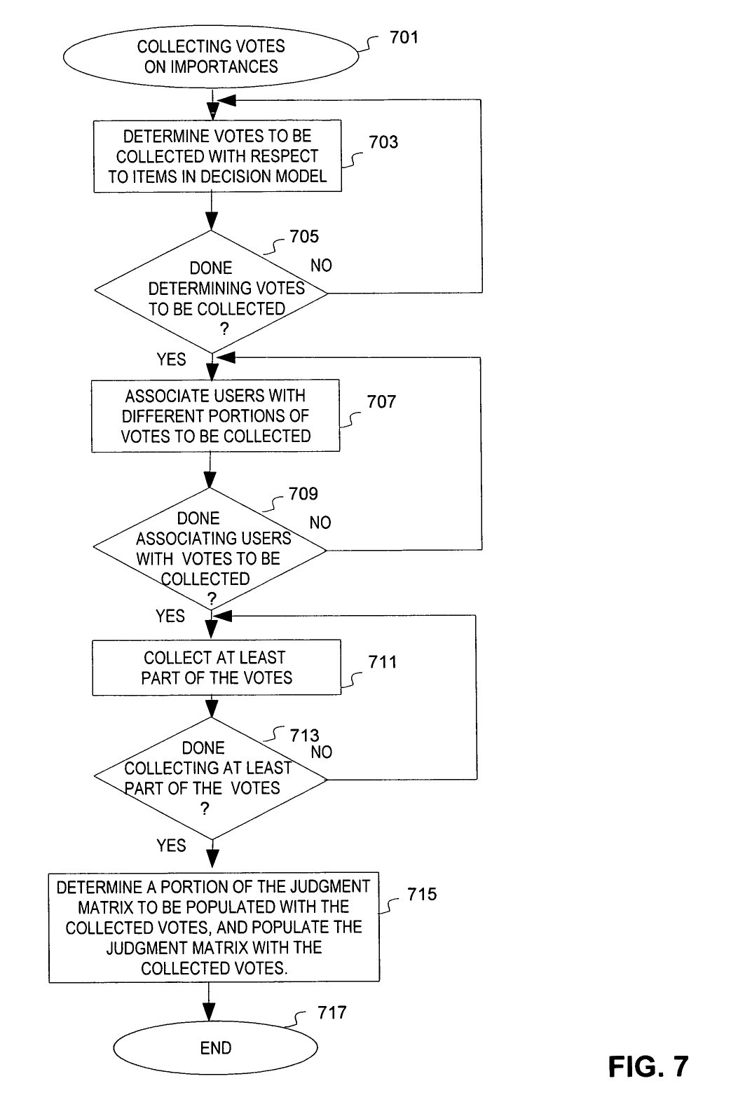

Referring now to FIG. 7, a flow chart illustrating an exemplary procedure for collecting votes on importances 701 in accordance with various exemplary and alternative exemplary embodiments will be discussed and described. The illustrated procedure can advantageously be implemented on, for example, a processor of a controller, such as was described in connection with FIG. 5, or other apparatus appropriately arranged. Accordingly, one or more embodiments provides a computer-implemented method for collecting votes on importances in an existing analytic network process (ANP) model, the ANP model having items which are influence linked.

In overview, one or more embodiments of the procedure for collecting votes on importances 701 can include, for example, determining 703, 705 the votes to be collected with respect to items in the decision model; associating 707, 709 users with different portions of votes to be collected; collecting 711, 713 at least part of the votes; determining 715 a portion of the judgment matrix to be populated with the collected votes and populating the judgment matrix with the collected votes. Each of these is described in more detail below.

The procedure can including determining 703 the votes to be collected with respect to items in the decision model. Not all votes need to be collected each time for the decision model. For example, when a decision model is provided, one can indicate which of the potential votes are to be collected, including by selecting a super matrix, a judgment matrix, and/or item(s) (e.g., control criteria, element, cluster). The procedure can loop to determine additional votes, if not done 705 determining the votes to be collected. Accordingly, one or more embodiments can provide for determining votes to be collected, wherein the votes are with respect to items in the ANP model, the items being influence linked, wherein a vote represents an importance of at least two influence linked items; and wherein a type of an item is a control criteria, an element, or a cluster.

Also, the procedure can provide for associating 707, 709 users with different portions of votes to be collected. For example, particular users can be associated with particular votes, including by associating particular users with votes related to a super matrix, a judgment matrix, item(s) (control criteria, element, cluster) and/or associating particular users with particular votes. Users can be associated with votes, for example, by manual or semi-manual indications, and/or automatically or semi-automatically in response to a role assigned to the user. The procedure can loop to associate additional users with votes, if not done 709 associating users with votes to be collected. Accordingly, one or more embodiments can provide for associating particular users with different respective portions of the votes to be collected. Furthermore, accordingly, one or more embodiments can provide for providing indications of a plurality of users from which to collect the votes; and associating respective portions of the votes with particular users, wherein votes to be collected are for at least two of a portion of a control criteria, an element, and a cluster.

The procedure further can provide for collecting 711 at least part of the votes. Votes can be collected as previously described. The procedure can loop to collect additional votes, if not done 713 collecting at least a part of the votes. Accordingly, one or more embodiments can provide for automatically or semi-automatically collecting, in the computer, at least a portion of the votes to provide collected votes, including first collecting votes on a plurality of pair of items where the items are in the same cluster, with respect to a different item that is in the same cluster or a different cluster, and second collecting votes on items where the items are clusters or control criteria.

Also, the procedure can provide for determining 715 a portion of the judgment matrix to be populated with the collected votes, and populating the judgment matrix with the collected votes. When a vote has been collected, the vote can be associated with an indication of the judgment matrix and location therein to which it belongs. Thus, when votes are collected, the judgment matrix, or portion thereof, to which the votes pertain, can be determined from the indications associated with the votes. Once the judgment matrix (or portion thereof) is determined, the collected votes can be populated into the judgment matrix.

In accordance with one or more embodiments, when the judgment matrix is populated, pairwise comparisons of the items corresponding to the votes are automatically performed. Accordingly, one or more embodiments can provide that populating the judgment matrix includes automatically performing, in the computer, pairwise comparisons of the items responsive to the collected votes.

Also, values such as priorities can be calculated from the judgment matrix. Accordingly, one or more embodiments can provide for automatically determining, in the computer, a portion of a judgment matrix representative of a portion of the ANP model to be populated responsive to the collected votes; and automatically populating, in the computer, the judgment matrix with the collected votes.

One or more embodiments provides for populating the priorities from the judgment matrix into a super matrix, where the super matrix represents one of the networks that comprise the decision model. When the procedure is done, it can end 717.

The foregoing description has suggested that one or more embodiment includes a communications capability. Devices providing communications capability can include those providing or facilitating voice communications services or data or messaging services over cellular wide area networks (WANs), such as conventional two way systems and devices, various cellular phone systems including analog and digital cellular, CDMA (code division multiple access) and variants thereof, GSM (Global System for Mobile Communications), GPRS (General Packet Radio System), 2.5G and 3G systems such as UMTS (Universal Mobile Telecommunication Service) systems, Internet Protocol (IP) Wireless Wide Area Networks like 802.16, 802.20 or Flarion, integrated digital enhanced networks and variants or evolutions thereof. Moreover, the communications capability that may be utilized in connection with one or more embodiments can include, for example, short range wireless communications capability normally referred to as WLAN (wireless local area network) capabilities, using CDMA, frequency hopping, OFDM (orthogonal frequency division multiplexing) or TDMA (Time Division Multiple Access) access technologies and one or more of various networking protocols, such as TCP/IP (Transmission Control Protocol/Internet Protocol), UDP/UP (Universal Datagram Protocol Universal Protocol), IPX/SPX (Inter-Packet Exchange/Sequential Packet Exchange), Net BIOS (Network Basic Input Output System), and/or other protocol structures. Alternatively communications may be provided in a wireline and/or wireless environment, for example, in accordance with a LAN using protocols such as TCP/IP, UDP/UP, IPX/SPX, or Net BIOS via a hardwired interface such as a cable and/or a connector or wireless interface. Moreover, communications may be provided by variations, extensions, evolutions, and/or combinations of such communications capabilities.

Furthermore, the devices of interest may include, without being exhaustive, a general purpose computer, a specially programmed special purpose computer, a personal computer, a distributed computer system, calculators, handheld, keypad, laptop/notebook, mini, mainframe, and super computers, personal digital assistants, communication devices, as well as networked combinations of the same, and the like, although other examples are possible as will be appreciated by one of skill in the art.

One or more embodiments may rely on the integration of various components including, as appropriate and/or if desired, hardware and software servers, database engines, and/or other content providers. One or more embodiments may be connected over a network, for example the Internet, an intranet, or even on a single computer system. Moreover, portions can be distributed over one or more computers, and some functions may be distributed to other hardware, in accordance with one or more embodiments.

Further, portions of various embodiments can be provided in any appropriate electronic format, including, for example, provided over a communication line as electronic signals, provided on floppy disk, provided on CD ROM, provided on optical disk memory, etc.

Any presently available or future developed computer software language and/or hardware components can be employed in various embodiments. For example, at least some of the functionality discussed above could be implemented using Visual Basic, C, C++, Java or any assembly language appropriate in view of the processor being used.

One or more embodiments may include a process and/or steps. Where steps are indicated, they may be performed in any order, unless expressly and necessarily limited to a particular order. Steps that are not so limited may be performed in any order.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A computer-implemented method for collecting votes on importances in an existing analytic network process (ANP) model, the ANP model having items which are influence linked, comprising:
determining votes to be collected, wherein the votes are with respect to items in the ANP model, the items being influence linked, wherein a vote represents an importance of at least two influence linked items; and wherein a type of an item is a control criteria, an element, or a cluster;
automatically or semi-automatically collecting, in the computer, at least a portion of the votes to provide collected votes, including
first collecting votes on a plurality of pair of items where the items are in the same cluster, with respect to a different item that is in the same cluster or a different cluster, and
second collecting votes on items where the items are clusters or control criteria.

2. The method of claim 1, further comprising associating particular users with different respective portions of the votes to be collected.

3. The method of claim 2, wherein at least one of the particular users is limited to voting on an associated one of the respective portions.

4. The method of claim 1, further comprising
automatically determining, in the computer, a portion of a judgment matrix representative of a portion of the ANP model to be populated responsive to the collected votes; and
automatically populating, in the computer, the judgment matrix with the collected votes.

5. The method of claim 4, wherein populating the judgment matrix includes automatically performing, in the computer, pairwise comparisons of the items responsive to the collected votes.

6. The method of claim 5, further comprising
calculating priorities from the judgment matrix; and
populating the priorities into a super matrix representing a network in the ANP model.

7. The method of claim 5, further comprising
calculating an average of plural judgment matrices including the judgment matrix; and
determining an average of the pairwise comparisons, wherein the votes in the judgment matrices are from different users.

8. The method of claim 5, further comprising automatically determining, in the computer, a plurality of items in the pairwise comparisons responsive to influence links of the items corresponding to the collected votes.

9. A computer readable medium comprising instructions for execution by a computer, the instructions including a computer-implemented method for determining voting for an existing analytic network process (ANP) model amongst users, the instructions for implementing:
providing an ANP model including first and second items which are influence linked, wherein an item is a cluster, a control criteria, or an element; and
determining the votes to be collected, wherein the votes are with respect to first items in the ANP model, the first items being influence linked to respective second items in the ANP model, wherein a vote represents an importance of respective first and second items.

10. The medium of claim 9, further comprising evaluating the first items to determine second items to which respective first items are influence linked.

11. The medium of claim 9, further comprising
associating respective portions of the votes to be collected with particular users in a plurality of users,
wherein one of the particular users can vote on the respective associated portion.

12. The medium of claim 11, further comprising
collecting votes on respective associated portions from respective ones of the particular users,
wherein the collecting further includes limiting information provided to the particular user about the ANP model to the respective associated portion of the ANP model.

13. The medium of claim 9, further comprising
collecting votes from a plurality of users, wherein a particular user can cast votes for a predetermined portion of the ANP model,
wherein the votes for a particular user reflect a user's indication of a relationship between a first item and at least two second items which are influence-linked to the first item.

14. The medium of claim 9, further comprising
providing indications of a plurality of users from which to collect the votes; and
associating respective portions of the votes with particular users,
wherein votes to be collected are for at least two of a portion of a control criteria, an element, and a cluster.

15. The medium of claim 9, further comprising
assigning users to respective roles; and
determining the users from which to collect the votes by determining votes corresponding to roles and users corresponding to roles.

16. A computer-implemented system for collecting information on importances of elements in a decision model, comprising:
an influence linked item determination unit, responsive to a first item, configured to facilitate automatically determining, in the computer, at least two respective second items to which the first item is influence linked in the decision model, wherein types of items in the decision model include control criteria, elements, and clusters;
a vote selection unit, configured to facilitate
selecting, responsive to a plurality of first items, plural sets of influence linked items on which votes are to be collected, wherein a vote represents an importance of influence linked items in respective sets; and
automatically or semi-automatically associating, in the computer, at least two respective second items in the respective set responsive to the respective first item, wherein the first item and the at least two respective second items in the respective set can have different types; and
a vote collection unit configured to facilitate collecting a plurality of votes between items in the respective sets.

17. The system of claim 16, wherein the vote selection unit associates, responsive to a user indicator, a particular user with a particular portion of the votes to be collected, and wherein the vote collection unit collects votes for the particular portion with respect to the user indicator.

18. The system of claim 16, wherein the vote selection unit associates, responsive to a user indicator, a particular user with a particular portion of the votes to be collected, and wherein the vote collection units limits each user to voting on a particular predetermined portion of the control criteria, elements, and clusters.

19. The system of claim 16, further comprising
a memory storing the decision model, the decision model having the items which are influence linked, including the first items and the second items; and
a decision model population unit, responsive to at least a portion of votes which have been collected, configured to facilitate populating the collected votes into a corresponding portion of the decision model.

20. The system of claim 16, wherein the vote collection unit is role-based.

21. The system of claim 16, wherein the importance represents a rating.

22. The system of claim 16, wherein the importance is relative to the influence linked items.
